(19) United States
(12) Patent Application Publication
(10) Pub. No.: US 2025/0206648 A1
(43) Pub. Date: Jun. 26, 2025

(54) A PROCESS FOR TREATING SLUDGE

(71) Applicant: YISSUM RESEARCH DEVELOPMENT COMPANY OF THE HEBREW UNIVERSITY OF JERUSALEM LTD., Jerusalem (IL)

(72) Inventors: Yoel SASSON, Tel Aviv (IL); Uri STOIN, Jerusalem (IL)

(21) Appl. No.: 18/849,418

(22) PCT Filed: Mar. 19, 2023
(86) PCT No.: PCT/IL2023/050284

§ 371 Date: Sep. 20, 2024

Related U.S. Application Data
(60) Provisional application No. 63/321,711, filed on Mar. 20, 2022.

(51) Int. Cl. C02F 11/143; C02F 3/28; C02F 11/04; C02F 11/06; C02F 101/30

(52) U.S. Cl. CPC C02F 11/143; C02F 3/28; C02F 11/04; C02F 11/06; C02F 2101/30

(57) ABSTRACT

The invention provides a process for treating sludge, comprising steps of digesting the sludge and/or dewatering the sludge, wherein either sludge digestion, sludge dewatering or both is (are) preceded by the addition of hydroxide compound and hydrogen peroxide to the sludge. Sludge treatment installation is also described.

Sewage is treated in wastewater treatment plants to recover usable water streams. The semisolid or solid by-product formed during the processing of sewage is known as sludge. Treatment of sludge is chiefly designed for reducing the sludge volume and converting the organic materials in the sludge into stable substances, to enable an effective disposal and ideally, recover a usable product, e.g., a nutrient-rich soil conditioner or fertilizer which can be applied, e.g., on agricultural land. The major processes to achieve these goals are sludge digestion, in which organic matter is biologically decomposed under the action of bacteria, and sludge dewatering, in which water is removed from the sludge.

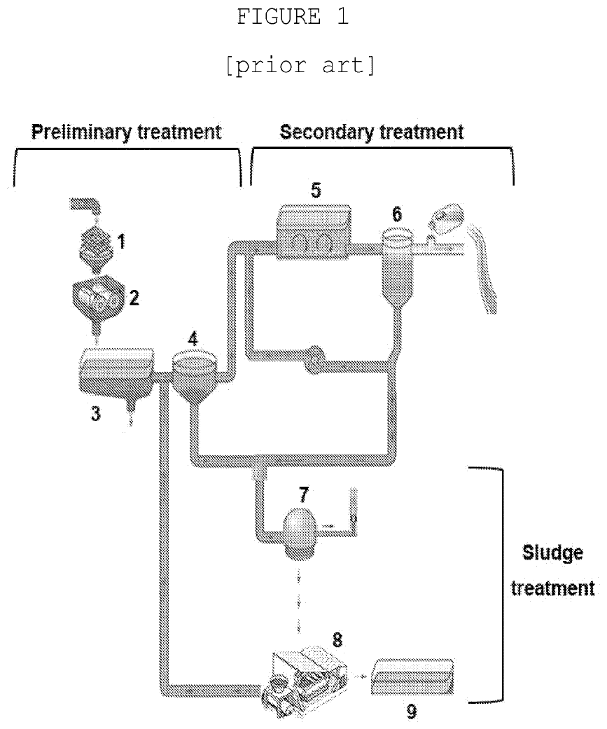

FIG. 1 is a schematic illustration of conventional processes carried out in a wastewater treatment plant, consisting of preliminary treatment zone, secondary treatment zone and sludge treatment and disposal zone (see https://www.britannica.com/explore/savingearth/wastewater-treatment).

In the preliminary treatment zone, screening, comminution, grit removal and sedimentation processes are used to remove floating or readily settleable material from the raw sewage stream. The raw sewage is passed through a set of closely spaced metal screens (1) to remove floating components such as wood and other coarse parts. Material that was not retained by the screens is received in a comminutor (2) where it is shredded; shredded material is later removed. Next, grit chambers (3)—long and narrow tanks which slow down the flow of the fluid—enable settling and separation of additional solid matter (e.g., sand) from the liquid. The last step in the preliminary treatment consists of clarifying the sewage in sedimentation tanks (primary clarifiers (4)). The solids which gradually sink to the bottom of the clarifier constitute a primary sludge. The primary sludge is removed mechanically from the clarifier, whereas the liquid stream is guided to the secondary treatment zone.

In the secondary treatment zone, soluble organic matter is separated from liquid stream through a biological process which takes place in aeration tank (5), where microbes consume the soluble organic matter, producing CO₂ and water. The effluent leaving aeration tank (5) is directed to a secondary clarifier (6), in which sedimentation occurs and water stream is recovered, which, following disinfection, can reach natural bodies of water (or proceed to a ternary treatment). The solid phase which settled in the secondary clarifier constitutes the secondary sludge.

As shown in FIG. 1, a joined stream of the preliminary and secondary sludges moves on to a sludge treatment and disposal zone. As pointed out above, sludge treatment includes digestion (7) and dewatering (8).

At the digestion step (7), organic solids in the sludge are decomposed by the action of bacteria (usually under anaerobic conditions). Usually the step is divided into two stages: the sludge is heated in a closed tank for a few days, during which period large molecules undergo decomposition, and organic matter is solubilized; then in a second tank, in the presence of different bacteria, dissolved organic matter is converted into biogas, which contains methane. In many sewage treatment plants, the methane produced can be used to fuel an electricity-generating unit which supplies electricity to the plant. As shown below, we use methane production as one of the benchmarks to assessing the efficiency of the invention.

Albeit its appearance resembling potted soil, digested sludge contains surprisingly large proportion of water, in fact, not less than 70%, and even as high as 90%. Removal of water-sludge dewatering—is necessary to reach acceptable sludge volumes for disposal. Dewatering (8) can be accomplished with (1) sludge-drying beds, i.e., by spreading the digested sludge on sand to dry the sludge over a fairly long time period, to obtain a sludge cake; and by mechanical methods, e.g., (2) filter press (3) centrifuge and (4) rotary drum vacuum filter. Disposable sludge is collected (9).

The goal of the invention is to solve problems associated with sludge digestion and sludge dewatering. One of the challenges in treating sludge is that a surprisingly large amount of water is trapped inside the sludge. The water is in fact locked inside the sludge, making sludge dewatering by the conventional mechanical methods mentioned above difficult to achieve. Another difficulty is encountered during sludge digestion: the interior of the sludge is not readily accessible to the action of bacteria. As shown in the experimental section below, progressively increasing amounts of an oxidizer to a typical sludge has no effect on the level of carbon oxygen demand (COD) measured; the level remains poor across a wide range of oxidizer concentration, indicating the organic matter in the sludge is not easily decomposable into a solubilized mater.

We have now found that sludge treatment (for example, sewage sludge treatment) could benefit from addition of a pre-digestion step and/or a pre-dewatering step, in which a sludge (primary sludge, mixture of primary and secondary sludge or even better, secondary sludge) is treated with a reagent consisting of hydroxide compound (e.g., MOH; M is an alkali metal, namely, sodium or potassium) and hydrogen peroxide (H₂O₂). Experimental results reported below show that a few benefits are gained from the proposed pre-digestion and/or pre-dewatering steps. When sludge digestion is preceded by pretreatment with the MOH/H₂O₂ reagent, the sludge is loosened, and decomposability of the sludge is increased (higher levels of soluble COD are measured in the sludge before the anaerobic digestion starts, owing to the partial oxidation of the sludge by the MOH/H₂O₂ reagent). When sludge dewatering is preceded by sludge conditioning with the MOH/H₂O₂ reagent, sludge drainability is greatly improved, such that dewatering is accomplished more effectively. Lastly, high quality sludge is obtained, meeting requirements of land application, e.g., as a fertilizer.

We have previously reported (WO 2013/093903 and Stoin, U. et al. ChemPhysChem, 2013, 14, 4158) the strong oxidizing action of the MOH/H₂O₂ reagent, ascribing this action to the in-situ generation of the superoxide radical anion (O₂⁻·), which is an active oxygen species that possesses both anionic and free radical properties. The MOH/H₂O₂ reagent has been found useful for various environmental activities, such as destruction of halogenated organic pollutants, carbon dioxide removal from flue gases (WO 2013093903); treatment of contaminated soil to eliminate persistent pollutants such as diesel oil and petroleum (WO 2015/170317, where it was shown that a variety of pollutants in the soil can be rapidly oxidized and totally mineralized); degradation of plastic waste (WO 2017/118975) dissolved in solution or in a molten state by the MOH/H₂O₂ reagent; removal of target gases from air, mainly carbon monoxide arising in case of fire (WO 2018/002710); indoor air applications (WO 2021/234713) and capture of CO₂ emission (WO 2022/130380).

Regarding treatment of waste streams, the use of alkali hydroxide and hydrogen peroxide in processing biomass was shown in WO 2015/101941, in conjunction with a catalytic reaction using iron catalyst.

Accordingly, the invention is primarily directed to a process for treating a sludge, comprising steps of digesting the sludge and/or dewatering the sludge, wherein either sludge digestion, sludge dewatering or both is(are) preceded by the addition of hydroxide compound and hydrogen peroxide to the sludge.

One variant of the invention relates to a process comprising adding hydroxide compound and hydrogen peroxide to the sludge before the digestion step to increase sludge decomposability, and then digesting a sludge with increased decomposability.

Another variant of the invention is a process comprising adding hydroxide compound and hydrogen peroxide to the sludge before the dewatering step to increase sludge drainability, and then dewatering a sludge with increased drainability.

The dewatered sludge collected by the process of the invention qualifies as class A sludge/biosolid with high concentration of KNP minerals and can therefore be applied to the landscape (at least 1% by weight of each of the KNP elements, e.g., from 1 to 10% potassium (e.g., 1-5%), from 1 to 8% nitrogen (e.g., 1 to 4%) and from 1 to 3% phosphorus (e.g., 1-2%). The term “Class A sludge biosolid” is referred as sludge that meets U.S. EPA guidelines for land application with no restrictions. Thus, class A biosolids can be legally used as fertilizer on farms, vegetable gardens, and can be sold to home gardeners as compost or fertilizer.

Alkali hydroxide (sodium hydroxide, potassium hydroxide or a mixture thereof) is added to the sludge either in a solid form or in an aqueous form, i.e., as an aqueous solution having concentration of not less than 1M, >3M, >5M, >6M, more preferably not less than 13M, e.g., from 1M to 25M. The main benefit received from using solid alkali hydroxide resides in that water is not loaded to the sludge that needs to be dewatered.

Hydrogen peroxide (in the form of aqueous solutions available on the marketplace, such as the industrial strength solutions of 6-50 w/v %, e.g., 30-50 w/v %, the 35 w/v % solution) is used in the invention.

The relative amounts of the hydrogen peroxide and alkali hydroxide are adjusted such that the molar ratio between the hydrogen peroxide and the hydroxide ion is preferably at least 1:1 (in favor of the H₂O₂), e.g., in the range of 1:1 to 2:1, with a ratio of 1.4:1 to 1.8:1, and especially about 1.5:1, being most preferred.

MOH and H₂O₂ can be added to the sludge separately (i.e., individual streams, injected or sprayed simultaneously or successively) or jointly (a combined stream prepared just before use, such that the resultant superoxide-containing aqueous solution can be used almost instantly, e.g., preferably within a period of time of not more than one minute, and even more preferably within less than five seconds, e.g., within one second, following the formation of the combined stream solution (this can be achieved with the aid of suitable mixers feeding the reagents below the surface of the sludge). In general, however, we obtained good results by gradual addition of hydrogen peroxide solution to a sludge to which the alkali hydroxide was previously added, e.g., hydrogen peroxide is added to a sludge after the pH of the sludge was adjusted to the alkaline range, e.g., of 8 to 14.

For example, when used to increase drainability of the sludge before the dewatering step, sludge pH can be from 10 to 13.

It is assumed that under the conditions described above, decomposition and mineralization of organic matter occurs rather swiftly (notably, the invention does not require the use of added metal (e.g., iron) catalyst):

CₓH_{y}+MO₂→M₂CO₃+H₂O+O₂

The invention also provides a sludge treatment installation, which comprises:
a digestion unit (optionally with a gas discharge conduit connected to an electricity-generating unit to convert gas evolving in said digestion unit into electricity); and/or
a dewatering unit producing disposable sludge; and
an oxidation unit placed upstream to said digestion unit or said dewatering unit, supplied with a first tank accommodating a hydroxide compound and a second tank accommodating hydrogen peroxide; wherein one or more sludge discharge lines enter said oxidation unit separately or jointly, and/or a discharge line of the digestion unit is connected to said oxidation unit to convey digested sludge to said oxidation unit, and wherein the feed line delivering sludge to the dewatering unit is connected either to the digestion unit, the oxidation unit or both.

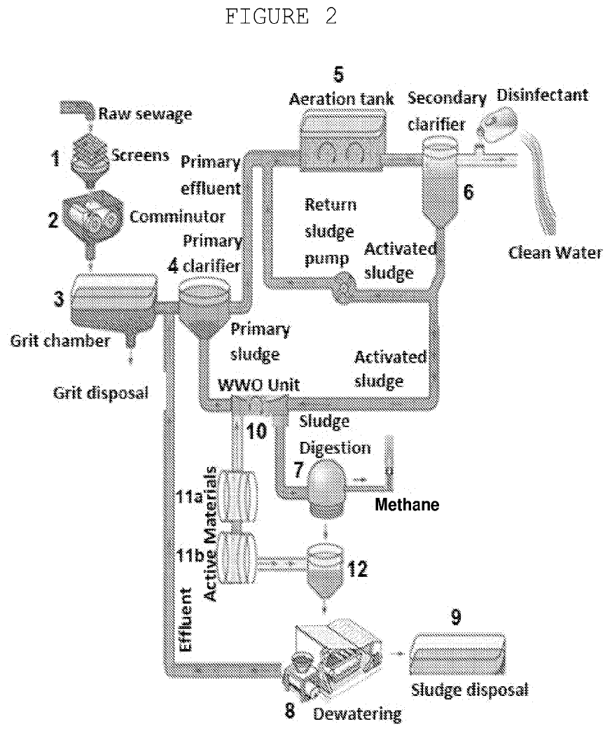

Thus, the sludge treatment installation includes either a digestion unit, a dewatering unit (or both) coupled to an oxidation unit. FIG. 2 illustrates the integration of an oxidation unit (wastewater oxidation (WWO) unit) into a sewage treatment plant, designed to treat sludge according to the invention. The modified sewage treatment plant consists of three major zones:
A) A primary treatment zone, comprising:
   A1) a separation device (1) in the form of an array of screens mounted one above another;
   A2) a comminutor (2) configured to receive material passing through said array of screens;
   A3) a grit chamber (3) positioned downstream to said comminutor (2);
   A4) a primary clarifier (4) adapted to receive a flow from grit chamber (3), wherein the primary clarifier is connected through a liquid discharge line to an aeration tank, and is provided with a first flowable solid (sludge) discharge line;
B) Secondary treatment zone, comprising:
   B1) an aeration tank (5);
   B2) a secondary clarifier (6);
wherein the aeration tank discharges to said secondary clarifier, which is provided with a liquid product discharge line and a second flowable solid (sludge) discharge line, with a pipe optionally diverging from said second flowable solid discharge line and forming a loop path with said aeration tank; and
C) A sludge treatment installation, comprising:
   C1) a digestion unit (7), optionally with gas discharge conduit connected to an electricity-generating unit (not shown) to convert gas evolving in said digestion unit into electricity;
   C2) a dewatering unit (8), producing disposable sludge (9); and
   C3) WWO unit (10, 12) placed upstream to said digestion unit (7) and/or said dewatering unit (8), supplied with a first tank (11a) accommodating a hydroxide compound and a second tank (11b) accommodating hydrogen peroxide; wherein the first and/or second flowable solid (sludge) discharge lines enter said oxidation unit (10) separately or jointly, and/or a discharge line of the digesting unit is connected to said WWO unit (12).

WWO unit integrated into sewage treatment plants (e.g., plants processing 5000-15,000 m³ of sewage per day) can operate under the following conditions. Sludge is delivered to the WWO unit (3-10 m³ volume reactor equipped with a suitable stirrer or stirrers, powered by a motor or rotated by the flow of the sludge) at a flow rate of 1 to 5 m³/h, using, e.g., standard liquid pumps in service at wastewater facilities, for example KSB pumps. The MOH/H₂O₂ stream(s) is(are) supplied to the WWO unit at a flow rate of 3.5 to 15 L per cubic meter of sludge, using peristaltic and stopper pumps such as, for example, ACME ASP 32 FX.

The added MOH/H₂O₂ are fed by spraying/injection under stirring (50 to 500 rpm). Residence time in the WWO unit is from 0.5 to 10 hours.

Thus, WWO unit of the invention comprises a stirred reactor, a pump supplying and discharging the incoming and outgoing sludge flows, respectively, tanks holding the reagents, pump(s) supplying the MOH/H₂O₂ reagents to the reactor connected to a spraying device (e.g., shower-like arrangement) or an array of pipes with nozzles, and in case of supplying alkali hydroxide in a solid form, a solid delivering unit.

Another aspect of the invention is a process comprising: screening raw sewage, comminuting the sewage, removing grit from the sewage, clarifying the sewage by sedimentation to produce a primary effluent and collect a primary sludge, removing soluble organic matter from the primary effluent to produce a secondary effluent stream and a secondary sludge, disinfecting the secondary effluent to produce a water stream, and wherein the process further comprises one of the following:
A) adding MOH and H₂O₂ to the preliminary sludge, the secondary sludge or their mixture to produce a partially oxidized sludge, digesting the partially oxidized sludge to create biogas and digested sludge (with increased VSS/TSS ratio measured during digestion), dewatering the digested sludge, and, when appropriate, applying the sludge to the landscape; or
B) digesting the combined sludge to create biogas and digested sludge, adding MOH and H₂O₂ to the digested sludge to produce a drainable sludge, dewatering the drainable sludge, and, when appropriate, applying the sludge to the landscape; or
C) adding MOH and H₂O₂ to the preliminary sludge, the secondary sludge or their mixture to produce a partially oxidized sludge, digesting the partially oxidized sludge to create biogas and digested sludge (with increased VSS/TSS ratio during digestion), adding MOH and H₂O₂ to the digested sludge to produce a drainable sludge, dewatering the drainable sludge, and, when appropriate, applying the sludge to the landscape.

The sludge that can be processed by the method of the invention may originate from different sources, e.g., from municipal, industrial and agricultural streams; livestock, crops, food waste, including manure and urine of livestock.

In the drawings:

FIG. 1 shows a conventional wastewater treatment plant.

FIG. 2 shows a wastewater treatment plant with WWO unit.

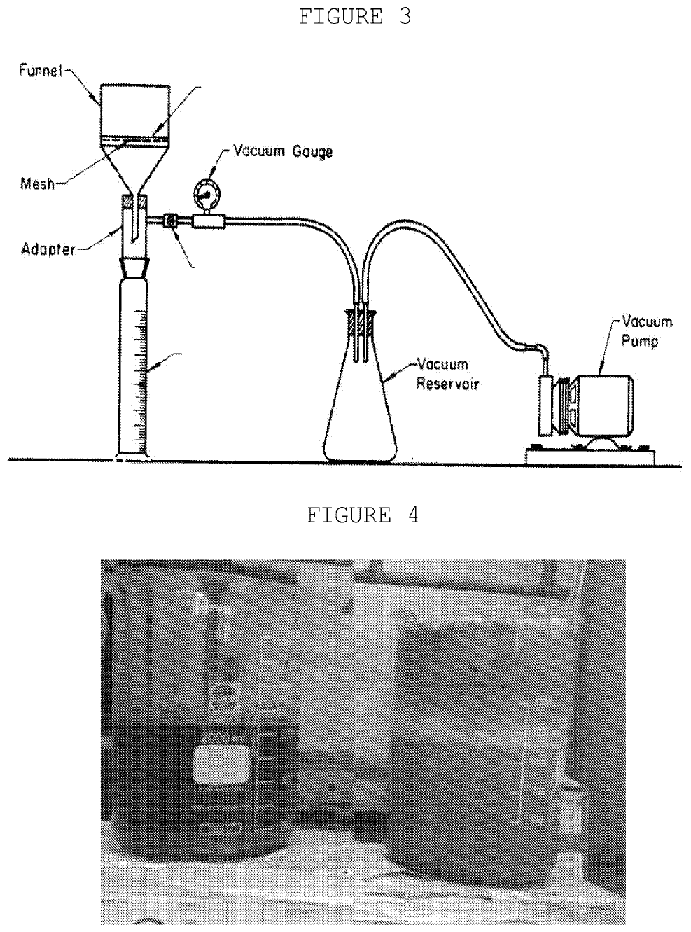

FIG. 3 schematically shows the experimental set-up used.

FIG. 4 shows sewage sludge before and after the treatment.

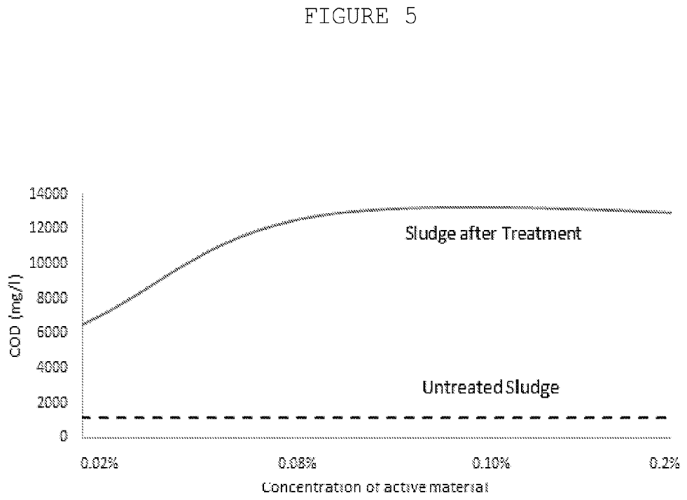

FIG. 5 is COD plot versus H₂O₂ concentration.

### EXAMPLES

### Examples 1 to 3

### Pre-Dewatering Treatment of Sludge (Lab Scale)

A series of experiments were performed to assess the effect of the MOH/H₂O₂ reagent on the separability of water from sludge samples collected in a digestion unit of a municipal wastewater plant before the sludge was delivered to the dewatering unit of the plant. The experiments were carried out at normal conditions on a laboratory scale.

A 2-Liter beaker was charged with 500 ml of sludge. Solid sodium hydroxide (1 g) was added to the beaker. The sludge was stirred at 300 rpm for ten minutes, following which hydrogen peroxide 35% solution (2 ml) was added dropwise for two minutes. Stirring was continued for sixty minutes.

After the treatment, the sludge was delivered to separation by filtration, as shown in FIG. 3, or centrifugal separation for 5 min under 4,000 rpm (the type of centrifuge: CENHBN-600ML-3, MRC Ltd., Israel), to determine the amount of water that can be removed from the sludge. The experimental set-up shown in FIG. 3 illustrates separation by filtration, i.e., gravimetric separation using a Buchner funnel fitted with an adapter into a graduated cylinder, to measure the volume of water released from the sludge, connected to a vacuum reservoir by rubber tubing which is attached to a vacuum pump.

The results are shown in Table 1. Similar filtration/centrifugation experiments were performed on non-treated sludge samples, and the improvement achieved by the action of the MOH/H₂O₂ reagent on the sludge was calculated.

TABLE 1

| | % of water released | % of water released |
|---|---|---|
| | from sludge by | from sludge by |
| Example* | Buchner separation | centrifugal separation |
| 1A | 12 | 23 |
| 1B | 30 | 56 |
| Improvement | 250 | 243 |
| 2A | 15 | — |
| 2B | 40 | — |
| Improvement | 267 | — |
| 3A | 25 | — |
| 3B | 60 | — |
| Improvement | 240 | — |

*1, 2, and 3 refer to different batches; “A” indicates nontreated sample, “B” indicates treated sample.

The results of the filtration/centrifugation experiments indicate that the drainability of the sludge was greatly improved by the action of the MOH/H₂O₂ reagent.

FIG. 4 is a photograph showing sewage sludge before and after the treatment (left and right, respectively). The effect of the treatment is visible.

### Example 4

### Pre-Digestion Treatment of Sludge (Lab Scale)

The goal of the experiment was to assess the effect of the MOH/H₂O₂ reagent in rendering the sludge more reactive to anaerobic digestion. The sludge sample was a secondary sludge, i.e., it was collected from a secondary clarifier of a municipal wastewater plant, before it was delivered to the digestion unit of the plant. The experiments were carried out at normal conditions on a laboratory scale.

A 2-Liter beaker was charged with 500 ml of a secondary sludge sample. Aqueous mixture of sodium and potassium hydroxide 50% solution (0.5 ml) was added to the beaker. The sludge was stirred at 500 rpm for ten minutes, following which hydrogen peroxide 35% solution (1 ml) was added dropwise for two minutes. Stirring was continued for 120 minutes.

After the treatment, the COD of the treated sludge was measured and compared to untreated sludge. Results are shown in FIG. 5, in the form of a COD plot versus concentration of the oxidizing agent used (H₂O₂). It is seen that the Carbon Oxygen Demand of the treated sludge is significantly higher, indicating that the treated sludge would be more easily digestible.

### Example 5

### Pre-Digestion and Pre-Dewatering Treatments of Sludge (Pilot Scale)

The ability of the MOH/H₂O₂ reagent to improve the reactivity of sludge towards digestion was studied in a field test performed in a wastewater treatment plant. The sample that was tested consisted of a mixture of sludge collected from preliminary and secondary clarifiers. The plant includes an electricity-generating unit, where methane (formed by the conversion of dissolved matter by bacteria in the digestion unit) is burned to produce electricity to power the plant.

Sludge was pumped from the preliminary and secondary clarifiers of the plant at an equal flow rate of 2 m³/h to a treatment unit, where it was mixed. Aqueous mixture of sodium and potassium hydroxide solutions (50% by weight) and hydrogen peroxide solution (35% by weight) are held in separate tanks in the treatment unit. In typical experiments, the individual solutions were either sprayed simultaneously to the mixed sludge, each at a rate of 3 L/m³ of sludge mixture, or were combined just before use, and the mixed reagent was rapidly applied to the sludge. A typical treatment lasted for about two to four hours and was performed under NTP conditions and continuous stirring.

After the treatment, the treated sludge was fed to the digestion unit of the plant. sCOD (soluble COD), VSS (volatile suspended solids; TSS is total volatile solids) and VFA (volatile fatty acid) were measured in the reaction mixture; biogas generation was measured in the electricity-generating unit of the plant, where the methane is burned. The final sludge quantity was measured before the dewatering unit. The results are shown in Table 2.

TABLE 2

| Parameter | Increase (%) | Decrease (%) |
|---|---|---|
| sCOD | 100% | |
| VFA | 35 | |
| VSS | 10 | |
| Biogas | 50 | |
| Phosphorus | | 35 (in |
| | | solution) |
| Sludge | | 20 |

The results indicate a significant enhancement of biogas production during sludge digestion and reduction of sludge volume to be disposed of. Furthermore, analysis of the product recovered following dewatering step indicates the formation of class A sludge, i.e., with negligible amounts of pathogens alongside high concentrations of the valuable KNP elements, as shown below:
KNP and trace components: K=5%, N=4%, P=1%, S=0.6%, Ca=0.2%, Mg=0.1%, Na=0.6%.
Biological contaminants: Coliform Bacteria=1000 MPN; Fecal Coliform=1000 MPN; E. coli=1000 MPN, salmonella=2.9 MPN.
[Metals, phosphorus and sulfur were measured by ICP-MS and elementary analysis equipment; for biological leftovers and others, measurements were carried out under ISO 17025 IEC/ISO].

1) A process for treating sludge, comprising steps of digesting the sludge and/or dewatering the sludge, wherein either sludge digestion, sludge dewatering or both is(are) preceded by the addition of hydroxide compound and hydrogen peroxide to the sludge.

2) A process according to claim 1, comprising adding hydroxide compound and hydrogen peroxide to the sludge before the digestion step to increase sludge decomposability, and then digesting a sludge with increased decomposability.

3) A process according to claim 1, comprising adding hydroxide compound and hydrogen peroxide to the sludge before the dewatering step to increase sludge drainability, and then dewatering a sludge with increased drainability.

4) A process according to claim 1, comprising:
passing raw sewage through a set of closely spaced screens, comminuting the sewage, removing grit from the sewage to produce an effluent, clarifying the effluent to produce a primary effluent and a primary sludge, removing soluble organic matter from the primary effluent to produce a secondary effluent stream and a secondary sludge, disinfecting the secondary effluent to produce a water stream, adding MOH and H₂O₂ to the primary sludge, the secondary sludge or their mixture, wherein M is an alkali metal, to produce a partially oxidized sludge, digesting the partially oxidized sludge to create biogas and digested sludge, and dewatering the digested sludge.

5) A process according to claim 1, comprising:
passing raw sewage through a set of closely spaced screens, comminuting the sewage, removing grit from the sewage to produce an effluent, clarifying the effluent to produce a primary effluent and a primary sludge, removing soluble organic matter from the primary effluent to produce a secondary effluent stream and a secondary sludge, disinfecting the secondary effluent to produce a water stream, combining the primary sludge and the secondary sludge, digesting the combined sludge to create biogas and digested sludge, adding MOH and H₂O₂ to the digested sludge, wherein M is an alkali metal, to produce a drainable sludge, and dewatering the drainable sludge.

6) A process according to claim 1, comprising:
screening raw sewage, comminuting the sewage, removing grit from the sewage, clarifying the sewage by sedimentation to produce a primary effluent and collect a primary sludge, removing soluble organic matter from the primary effluent to produce a secondary effluent stream and a secondary sludge, disinfecting the secondary effluent to produce a water stream, adding MOH and H₂O₂ to the primary sludge, the secondary sludge or their mixture, wherein M is an alkali metal, to produce a partially oxidized sludge, digesting the partially oxidized sludge to create biogas and digested sludge, adding MOH and H₂O₂ to the digested sludge to produce a drainable sludge, and dewatering the drainable sludge.

7) A process according to claim 1, wherein the hydroxide is alkali hydroxide selected from sodium hydroxide and potassium hydroxide, which is added to the sludge in a solid form or as an aqueous solution having concentration of not less than 1M.

8) A process according to claim 7, wherein hydrogen peroxide is added as 6-50 w/v % solution.

9) A process according to claim 7, wherein the relative amounts of the hydrogen peroxide and the alkali hydroxide are adjusted such that the molar ratio between the hydrogen peroxide and the hydroxide ion is in the range of 1:1 to 2:1.

10) A process according to claim 1, comprising gradual addition of hydrogen peroxide solution to a sludge to which the alkali hydroxide was previously added.

11) A process according to claim 1, wherein the source of the sludge is from municipal, industrial and agricultural streams, livestock, crops, food waste, including livestock manure and urine.

12) A process according to claim 1, further comprising a step of collecting a dewatered sludge qualifying as class A sludge/biosolid, with at least 1% by weight of each of the KNP elements.

13) Sludge treatment installation, comprising:
a digestion unit, optionally with gas discharge conduit connected to an electricity-generating unit to convert gas evolving in said digestion unit into electricity; and/or
a dewatering unit producing disposable sludge;
wherein the sludge treatment installation further comprises an oxidation unit placed upstream to said digestion unit or said dewatering unit, supplied with a first tank accommodating a hydroxide compound and a second tank accommodating hydrogen peroxide; wherein one or more sludge discharge lines enter said oxidation unit separately or jointly, and/or a discharge line of the digestion unit is connected to said oxidation unit to convey digested sludge to said oxidation unit, and wherein the feed line delivering sludge to the dewatering unit is connected either to the digestion unit, the oxidation unit or both.

14) Sludge treatment installation according to claim 13, wherein the oxidation unit comprises a stirred reactor, a pump supplying and discharging the incoming and outgoing sludge flows, respectively, pump(s) supplying the MOH/H₂O₂ reagents to the reactor connected to a spraying device or an array of pipes with nozzles, and in case of supplying alkali hydroxide in a solid form, a solid delivering unit.

15) Wastewater treatment plant which includes the sludge treatment installation of claim 13, the plant comprising:
A) A primary treatment zone, comprising:
A1) a separation device in the form of an array of screens mounted one above another;
A2) a comminutor connected to receive material passing through said array of screens;
A3) a grit chamber positioned downstream to said comminutor;
A4) a primary clarifier adapted to receive a flow from said grit chamber, wherein the primary clarifier is connected through a liquid discharge line to an aeration tank, and is provided with a first flowable solid discharge line;
B) Secondary treatment zone, comprising:
B1) An aeration tank;
B2) A secondary clarifier;
wherein the aeration tank discharges to said secondary clarifier, which is provided with a liquid product discharge line and a second flowable solid discharge line, with a pipe diverging from said second flowable solid discharge line and forming a loop path with said aeration tank; and
C) Sludge treatment installation, comprising:
C1) a digestion unit, optionally with gas discharge conduit connected to an electricity-generating unit to convert gas evolving in said digestion unit into electricity;
C2) a dewatering unit producing disposable sludge; and
C3) an oxidation unit.
